(19) United States
(12) Patent Application Publication
(10) Pub. No.: US 2020/0211302 A1
(43) Pub. Date: Jul. 2, 2020

(54) CONTROL DEVICE FOR MULTI-DRIVER COMPATIBILITY AND IMPLEMENTATION METHOD

(71) Applicant: AUTEL INTELLIGENT TECHNOLOGY CORP., LTD., Shenzhen (CN)

(72) Inventor: Weilin Wang, Shenzhen (CN)

(21) Appl. No.: 16/818,828

(22) Filed: Mar. 13, 2020

Related U.S. Application Data
(63) Continuation of application No. PCT/CN2018/105312, filed on Sep. 12, 2018.

(30) Foreign Application Priority Data
Sep. 14, 2017 (CN) 201710829140.3

(51) Int. Cl. G07C 5/08; G07C 5/00

(52) U.S. Cl. CPC G07C 5/0808; G07C 5/008; G07C 5/0841

(57) ABSTRACT

Embodiments of the present invention relate to the field of computer technologies, and disclose a data sharing method, a data sharing apparatus and a mobile terminal. The method includes: receiving a vehicle model selection instruction; determining a selected vehicle model according to the vehicle model selection instruction; and invoking a diagnostic module of a vehicle line corresponding to the selected vehicle model according to the selected vehicle model, to diagnose the selected vehicle model, where the vehicle line includes a plurality of different vehicle models, and the plurality of different vehicle models shares the diagnostic module of the vehicle line. Vehicle models adopting a same vehicle line share a same diagnostic module, thus implementing sharing of diagnostic data. As a result, storage space occupied by a diagnostic module in a diagnostic tool and maintenance costs are reduced.

This application is a continuation application of International Application No. PCT/CN2018/105312, filed on Sep. 12, 2018, which claims priority of Chinese Patent Application No. 201710829140.3, filed on Sep. 14, 2017, which is incorporated herein by reference in its entirety.

### BACKGROUND

### Technical Field

The present application relates to the field of computer technologies, and in particular, to a data sharing method, a data sharing apparatus and a mobile terminal.

### Related Art

In modern vehicle control, an electronic control technology is basically adopted, which controls operations of modules such as an engine, an anti-lock brake system (ABS), a vehicle body, a chassis and a gearbox through an electronic control unit (ECU). In addition, vehicle fault information is also recorded in the ECU. The vehicle fault information is generally stored in the ECU in a form of a fault code. If the vehicle fault information needs to be analyzed, an instruction identifiable by the ECU needs to be sent by a vehicle diagnostic module, to read the fault code and translate the fault code into fault code information identifiable by a person. In this way, a vehicle maintenance engineer can be guided to perform a maintenance operation. A computer that runs the diagnostic module is a diagnostic tool.

In the prior art, the diagnostic tool running the diagnostic module is generally a handheld or mobile embedded computer system, and a computing capability and storage space of the diagnostic tool are limited.

In a procedure of implementing the present invention, it is discovered that in the related art, there are at least the following problems: because functions of a current diagnostic module become more powerful, more advanced functions and special services need to be supported, for example, action tests, maintenance resetting and brake pad replacement. In addition, maintenance tools further need to repair vehicles of a plurality of brands and a plurality of models. Therefore, larger storage space of the diagnostic module is required. Currently, the computing capability and the storage space of the diagnostic tool of the handheld or mobile or embedded computer system are limited. As a result, the storage space of the diagnostic tool is in shortage. In addition, with an increase in vehicle models, the quantity of diagnostic modules is increasing, which leads to high costs of maintaining the diagnostic modules.

### SUMMARY

A main objective of embodiments of the present invention is to provide a data sharing method, a data sharing apparatus and a mobile terminal, to implement sharing of diagnostic data, that is, implement sharing of the diagnostic module. As a result, storage space occupied by the diagnostic module in a diagnostic tool and maintenance costs are reduced.

Embodiments of the present invention disclose the following technical solutions:

According to a first aspect, an embodiment of the present invention provides a data sharing method, applied to a mobile terminal, the method including:

receiving a vehicle model selection instruction;

determining a selected vehicle model according to the vehicle model selection instruction; and

invoking a diagnostic module of a vehicle line corresponding to the selected vehicle model according to the selected vehicle model, to diagnose the selected vehicle model, where the vehicle line includes a plurality of different vehicle models, and the plurality of different vehicle models shares the diagnostic module of the vehicle line.

Optionally, the invoking a diagnostic module of a vehicle line corresponding to the selected vehicle model according to the selected vehicle model includes:

obtaining a configuration file of the selected vehicle model;

obtaining, from the configuration file, configuration information of the selected vehicle model;

obtaining storage location information of the diagnostic module of the vehicle line corresponding to the selected vehicle model according to the configuration information, where the storage location information is used for indicating a storage location of the diagnostic module of the vehicle line; and

invoking the diagnostic module of the vehicle line according to the storage location information.

Optionally, the configuration information includes the storage location information of the diagnostic module of the vehicle line and version information of the diagnostic module of the vehicle line.

Optionally, the configuration information further includes attribute information of the selected vehicle model.

Optionally, the invoking a diagnostic module of a vehicle line corresponding to the selected vehicle model includes:

obtaining a global configuration file of the diagnostic module; and

invoking a sub-module of the diagnostic module according to the global configuration file.

Optionally, the invoking a sub-module of the diagnostic module includes:

determining, according to the selected vehicle model, a sub-module to be invoked, where at least one sub-module is invoked.

Optionally, the sub-module includes at least one program library file obtained through division according to a diagnostic function.

Optionally, the invoking a diagnostic module of a vehicle line corresponding to the selected vehicle model includes:

loading a dynamic library of the diagnostic module of the vehicle line, and obtaining a handle of the dynamic library;

positioning an address of an entry-point function of the diagnostic module according to the handle, and obtaining a function pointer of the entry-point function; and

invoking the diagnostic module according to the function pointer.

Optionally, the method further includes:

performing classification processing according to at least one of a code reading manner, fault code translation, a maintenance guidance method and a vehicle model attribute, to set a correspondence between vehicle models and vehicle lines.

Optionally, the receiving a vehicle model selection instruction includes:

receiving a vehicle model selection instruction entered by a user; or

receiving a vehicle model selection instruction sent by an external device,

Optionally, the diagnostic module includes at least one of the following:

a function library, a database and an interface.

According to a second aspect, an embodiment of the present invention provides a data sharing apparatus, applied to a mobile terminal, the apparatus including:

a selection instruction receiving unit, configured to receive a vehicle model selection instruction;

a vehicle model determining unit, configured to determine a selected vehicle model according to the vehicle model selection instruction; and

a first invoking unit, configured to invoke a diagnostic module of a vehicle line corresponding to the selected vehicle model according to the selected vehicle model, to diagnose the selected vehicle model, where the vehicle line includes a plurality of different vehicle models, and the plurality of different vehicle models shares the diagnostic module of the vehicle line.

Optionally, the first invoking unit is specifically configured to:

obtain a configuration file of the selected vehicle model;

obtain, from the configuration file, configuration information of the selected vehicle model;

obtain storage location information of the diagnostic module of the vehicle line corresponding to the selected vehicle model according to the configuration information, where the storage location information is used for indicating a storage location of the diagnostic module of the vehicle line; and

invoke the diagnostic module of the vehicle line according to the storage location information.

Optionally, the configuration information includes the storage location information of the diagnostic module of the vehicle line and version information of the diagnostic module of the vehicle line.

Optionally, the configuration information further includes attribute information of the selected vehicle model.

Optionally, the first invoking unit includes:

a global configuration file obtaining unit, configured to obtain a global configuration file of the diagnostic module; and

a second invoking unit, configured to invoke a sub-module of the diagnostic module according to the global configuration file.

Optionally, the invoking, by the second invoking unit, a sub-module of the diagnostic module includes:

determining, according to the selected vehicle model, a sub-module to be invoked, where at least one sub-module is invoked.

Optionally, the sub-module includes at least one program library file obtained through division according to a diagnostic function.

Optionally, the invoking, by the first invoking unit, a diagnostic module of a vehicle line corresponding to the selected vehicle model includes:

loading a dynamic library of the diagnostic module of the vehicle line, and obtaining a handle of the dynamic library;

positioning an address of an entry-point function of the diagnostic module according to the handle, and obtaining a function pointer of the entry-point function; and

invoking the diagnostic module according to the function pointer.

Optionally, the apparatus further includes:

a classification processing unit, configured to perform classification processing according to at least one of a code reading manner, fault code translation, a maintenance guidance method and a vehicle model attribute, to set a correspondence between vehicle models and vehicle lines.

Optionally, the selection instruction receiving unit is specifically configured to:

receive a vehicle model selection instruction entered by a user; or

receive a vehicle model selection instruction sent by an external device.

Optionally, the diagnostic module includes at least one of the following:

a function library, a database and an interface.

According to a third aspect, an embodiment of the present invention provides a mobile terminal, including:

at least one processor; and

a memory communicatively connected to the at least one processor; where

the memory stores instructions executable by the at least one processor, the instructions being executed by the at least one processor to cause the at least one processor to perform the foregoing data sharing method.

According to a fourth aspect, an embodiment of the present invention provides a computer program product, including a computer program stored in a non-volatile computer-readable storage medium. The computer program includes a program instruction, the program instruction, when being executed by a mobile terminal, causing the mobile terminal to perform the foregoing data sharing method.

According to a fifth aspect, an embodiment of the present invention further provides a non-volatile computer-readable storage medium storing a computer executable instruction, the computer executable instruction being used for causing a mobile terminal to perform the foregoing data sharing method.

Embodiments of the present invention have the following beneficial effects: different from the prior art, in the embodiments of the present invention, vehicle models adopting a same vehicle line share a same diagnostic module, thereby implementing sharing of diagnostic data, that is, implementing sharing of the diagnostic module. As a result, storage space occupied by the diagnostic module in a diagnostic tool and maintenance costs are reduced.

### BRIEF DESCRIPTION OF THE DRAWINGS

One or more embodiments are described by way of example with reference to the corresponding figures in the accompanying drawings, and the descriptions are not to be construed as limiting the embodiments. Elements in the accompanying drawings that have same reference numerals are represented as similar elements, and unless otherwise particularly stated, the figures in the accompanying drawings are not drawn to scale.

FIG. 1 is a schematic flowchart of a data sharing method according to embodiment of the present invention;

FIG. 2 is a schematic flowchart of a data sharing method according to an embodiment of the present invention;

FIG. 3 is a schematic diagram of a correspondence between vehicle lines and diagnostic modules according to an embodiment of the present invention;

FIG. 4 is a schematic diagram of a plurality of functional modules according to an embodiment of the present invention;

FIG. 5 is a schematic diagram of a data sharing apparatus according to an embodiment of the present invention;

FIG. 6 is a schematic diagram of a data sharing apparatus according to an embodiment of the present invention; and

FIG. 7 is a schematic structural diagram of hardware of a mobile terminal according to an embodiment of the present invention.

### DETAILED DESCRIPTION

To make the objectives, technical solutions, and advantages of the present invention more comprehensible, the technical solutions embodiments of the present invention are clearly and completely described in the following with reference to the accompanying drawings in the embodiments of the present invention. Apparently, the embodiments in the following description are merely some, rather than all, of the embodiments of the present invention. All other embodiments obtained by a person of ordinary skill in the art based on the embodiments of the present invention without creative efforts shall fall within the protection scope of the present disclosure.

In addition, technical features that are described in the following and that are related to implementations of the present invention can be combined, as long as there are no conflicts and contradictions between the technical features.

### Embodiment 1

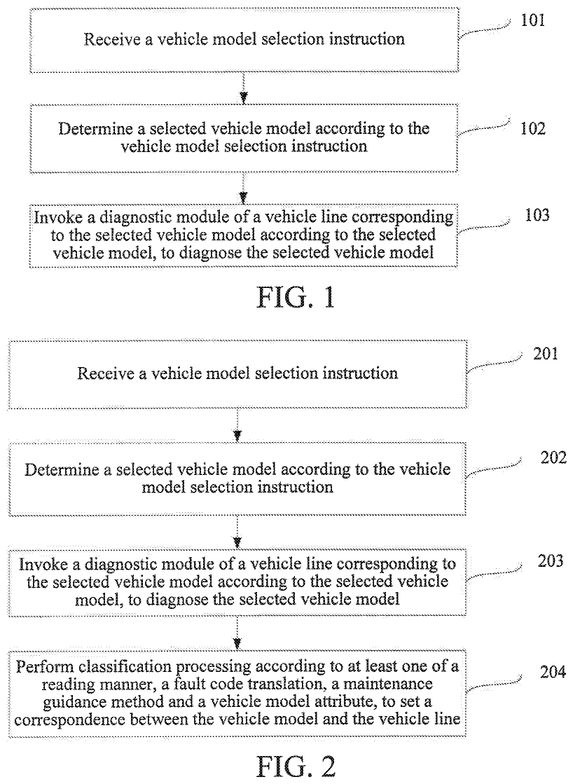

This embodiment of the present invention is an embodiment of a data sharing method provided by the present invention. FIG. 1 is a schematic flowchart of a data sharing method according to an embodiment of the present invention. The data sharing method in this embodiment of the present invention is applied to a mobile terminal. The data sharing method may be performed by different mobile terminals such as a vehicle diagnostic instrument and an embedded computer. That is, devices, which can store or run diagnostic software or a diagnostic module, are the mobile terminals in this embodiment of the present invention.

Referring to FIG. 1, the method includes:

101: Receive a vehicle model selection instruction.

In this embodiment of the present invention, a mobile terminal provides an interaction interface. The interaction interface displays an entry menu for a user to select a vehicle model, so that the user performs an operation of vehicle model selection through the entry menu, and a vehicle model selection instruction is generated. The mobile terminal receives the vehicle model selection instruction. The vehicle model may be determined based on information of a to-be-diagnosed vehicle, for example, a brand, a manufacturer, a production date or a vehicle identification number (VIN). Alternatively, the vehicle model is preset in the mobile terminal. For example, the vehicle model is a vehicle model formed based on the brand of the vehicle, for example, Audi, Bentley or Lamborghini.

In another implementation, the mobile terminal establishes a connection to the to-be-diagnosed vehicle and receives a vehicle model selection instruction of the to-be-diagnosed vehicle. The vehicle model selection instruction may include information such as the vehicle model of the to-be-diagnosed vehicle. For example, the vehicle model selection instruction carries the VIN of the to-be-diagnosed vehicle, or the vehicle model selection instruction directly carries the vehicle model of the to-be-diagnosed vehicle. As a result, the mobile terminal may determine a selected vehicle model according to the vehicle model selection instruction obtained from the to-be-diagnosed vehicle.

102: Determine a selected vehicle model according to the vehicle model selection instruction.

In this embodiment of the present invention, the mobile terminal may determine, according to the vehicle model selection instruction, a vehicle model selected by the user. For example, the selected vehicle model is Audi.

Alternatively, the mobile terminal parses the vehicle model selection instruction obtained from the to-be-diagnosed vehicle, and obtains a vehicle model in the vehicle model selection instruction through parsing. For example, when the vehicle model selection instruction carries the VIN of the to-be-diagnosed vehicle, the vehicle model of the to-be-diagnosed vehicle obtained from the VIN through parsing, or when the vehicle model selection instruction directly carries the vehicle model of the to-be-diagnosed vehicle, the vehicle model of the to-be-diagnosed vehicle is obtained from the vehicle model selection instruction through parsing. As a result, the selected vehicle model may be determined.

The vehicle model of the to-be-diagnosed vehicle is information for distinguishing the to-be-diagnosed vehicle from other types of vehicles. The vehicle model may include a plurality of types of identification information of the vehicle, for example, a model, a year-based style or a brand.

103: Invoke a diagnostic module of a vehicle line corresponding to the selected vehicle model according to the selected vehicle model, to diagnose the selected vehicle model.

In this embodiment of the present invention, a main procedure in which the diagnostic module diagnoses the vehicle model is as follows: sending a code reading instruction, reading a fault code and translating the fault code. For example, vehicle fault information is stored in a form of a fault code. To analyze vehicle fault information to implement diagnosis, the diagnostic module needs to send a code reading instruction, read the fault code according to the reading instruction, and translate the fault code into fault code information identifiable by a person. In this way, the diagnostic module may guide a vehicle maintenance user to perform a maintenance operation. The fault code is a code defining each fault; and the code reading is a procedure of sending a specific instruction to obtain the fault code.

Code reading manners, fault code translation, and maintenance guidance methods in a diagnosis procedure for a plurality of different vehicle models may be similar, or even the same. For example, the code reading manners are the same. Alternatively, if a plurality of different vehicle models belongs to one conglomerate, similar features may exist in some component modules (for example, an engine or an. ABS) of the vehicle models. For example, Audi and Volkswagen are both vehicle models belonging to Volkswagen, and share basic platforms such as a chassis and an engine. Therefore, Audi and Volkswagen can be classified into a Volkswagen line. If each diagnostic module merely diagnoses one vehicle model, the diagnostic module occupies relatively large storage space. As a result, the storage space of a diagnostic tool is in shortage, and maintenance costs of the diagnostic module are also increased.

Based on this, a diagnostic module corresponding to a vehicle line may be stored in the mobile terminal, and a to-be-diagnosed vehicle of any vehicle model in the vehicle line is diagnosed based on the diagnostic module. A correspondence between vehicle lines and vehicle models may be determined by the manufacturer of the vehicle. For example, Skoda and Audi both belong to the Volkswagen conglomerate, and therefore, a vehicle model of Audi and the same vehicle model of Skoda correspond to one vehicle line. Alternatively, some or all of vehicle models of Audi correspond to one vehicle line, or some or all of vehicle models of Skoda correspond to one vehicle line. Alternatively, the correspondence between vehicle lines and vehicle models may be determined by diagnostic similarity of component modules of the vehicles. For example, one diagnostic module may diagnose one or more modules of vehicles of a plurality of vehicle models, and therefore, the plurality of vehicle models corresponds to one vehicle line. Herein, the correspondence between vehicle lines and vehicle models may be fixed or set by default, or may be adjusted according to operations of the user. The correspondence is stored in the mobile terminal, or another device which can be obtained by the mobile terminal.

In this embodiment of the present invention, the mobile terminal invokes a diagnostic module of a vehicle line corresponding to the selected vehicle model according to the selected vehicle model, to diagnose the selected vehicle model. The vehicle line includes a plurality of different vehicle models, where the plurality of different vehicle models may be a same vehicle model of different brands, for example, a sport utility vehicle (SUV) vehicle model of Audi and Skoda. Alternatively, the plurality of different vehicle models may be some or all of vehicle models of one or more brands, for example, some or all of vehicle models of Audi and Skoda belong to one vehicle line. The plurality of different vehicle models shares a diagnostic module of the vehicle line. For example, it is preset that a diagnostic module diagnosing a Volkswagen vehicle line is a “diagnostic module 1”, and a diagnostic module diagnosing a Bavarian Motor Work (BMW) vehicle line is a “diagnostic module 2”. According to the vehicle model selection instruction, it is determined that the selected vehicle model is Audi, and a vehicle line to which Audi belongs is the Volkswagen line. Therefore, a diagnostic module invoked to diagnose Audi is the “diagnostic module 1”. If Bentley, Lamborghini, or the like also belongs to the Volkswagen line, when the selected vehicle model is Bentley or Lamborghini, the invoked diagnostic module is also the “diagnostic module 1”. By invoking the diagnostic module of the vehicle line corresponding to the selected vehicle model, vehicle models of a same vehicle line may share a same diagnostic module, thereby achieving an objective of sharing the diagnostic module, that is, achieving an objective of data sharing. That is, sharing a diagnostic module of the vehicle line by a plurality of different vehicle models means that the mobile terminal may invoke the same diagnostic module of the vehicle line to diagnose vehicles of different vehicle models. That is, the mobile terminal may invoke the same diagnostic module to diagnose vehicles of different vehicle models, thereby further improving the diagnostic compatibility of the mobile terminal, saving the storage space of the mobile terminal, and reducing the maintenance costs of the diagnostic module.

In this embodiment of the present invention, after the diagnostic module of the vehicle line corresponding to the selected vehicle model is invoked, the selected vehicle model may be diagnosed through the diagnostic module. For example, diagnosis on the selected vehicle model is implemented by loading a dynamic library of the diagnostic module. The dynamic library of the diagnostic module may be loaded through a dlopen function. In some embodiments, after the diagnosis is completed, the diagnostic function is exited, and the loaded dynamic library is released, so that the diagnostic module works normally when another vehicle model needs to be diagnosed.

The diagnostic module in this embodiment of the present application may be complete diagnostic software with a plurality of diagnostic functions, a diagnostic module with a particular function in diagnostic software, a sub-module of a diagnostic module with a particular function, a universal module in various diagnostic software, or the like.

In this embodiment of the present invention, vehicle models adopting a same vehicle line share a same diagnostic module, thereby implementing sharing of diagnostic data, that is, implementing sharing of the diagnostic module. As a result, storage space occupied by the diagnostic module in a diagnostic tool and maintenance costs are reduced.

### Embodiment 2

This embodiment of the present invention is an embodiment of a data sharing method provided by the present invention. FIG. 2 is a schematic flowchart of a data sharing method according to an embodiment of the present invention. The data sharing method in this embodiment of the present invention is applied to a mobile terminal. The data sharing method may be performed by different mobile terminals such as a vehicle diagnostic instrument and an embedded computer. That is, devices, which can store or run diagnostic software or a diagnostic module, are the mobile terminals in this embodiment of the present invention.

Referring to FIG. 2, the method includes:

201: Receive a vehicle model selection instruction.

In this embodiment of the present invention, the receiving a vehicle model selection instruction includes: receiving a vehicle model selection instruction entered by a user; or receiving a vehicle model selection instruction sent by an external device, for example, receiving a vehicle model selection instruction sent by another mobile terminal, Herein, the external device may include another mobile terminal or a to-be-diagnosed vehicle.

202: Determine a selected vehicle model according to the vehicle model selection instruction.

203: Invoke a diagnostic module of a vehicle line corresponding to the selected vehicle model according to the selected vehicle model, to diagnose the selected vehicle model.

In this embodiment of the present invention, the mobile terminal invokes a diagnostic module of a vehicle line corresponding to the selected vehicle model according to the selected vehicle model, to diagnose the selected vehicle model, where the vehicle line includes a plurality of different vehicle models, and the plurality of different vehicle models shares the diagnostic module of the vehicle line. The diagnostic module may be implemented through at least one of the following manners: a function library, a database and an interface. The invoking a diagnostic module of a vehicle line corresponding to the selected vehicle model according to the selected vehicle model, to diagnose the selected vehicle model may include: obtaining a configuration file of the selected vehicle model; obtaining, front the configuration file, configuration information of the selected vehicle model; obtaining storage location information of the diagnostic module of the vehicle line corresponding to the selected vehicle model according to the configuration information; and invoking the diagnostic module of the vehicle line according to the storage location information, where the storage location information is used for indicating a storage location of the diagnostic module of the vehicle line. The configuration information includes the storage location information of the diagnostic module of the vehicle line, version information of the diagnostic module of the vehicle line, attribute information of the selected vehicle model, and the like. The version information of the diagnostic module may include a version number of the diagnostic module. Alternatively, a type of the diagnostic module may be determined through the version information of the diagnostic module, for example, it is determined that the diagnostic module is of a standard version, a professional version or an enterprise version. The attribute information of the vehicle model may include a name, a model, and the like of the vehicle model. Quick matching may be performed through the attribute information of the vehicle model included in the configuration file, to obtain the configuration file of the selected vehicle model.

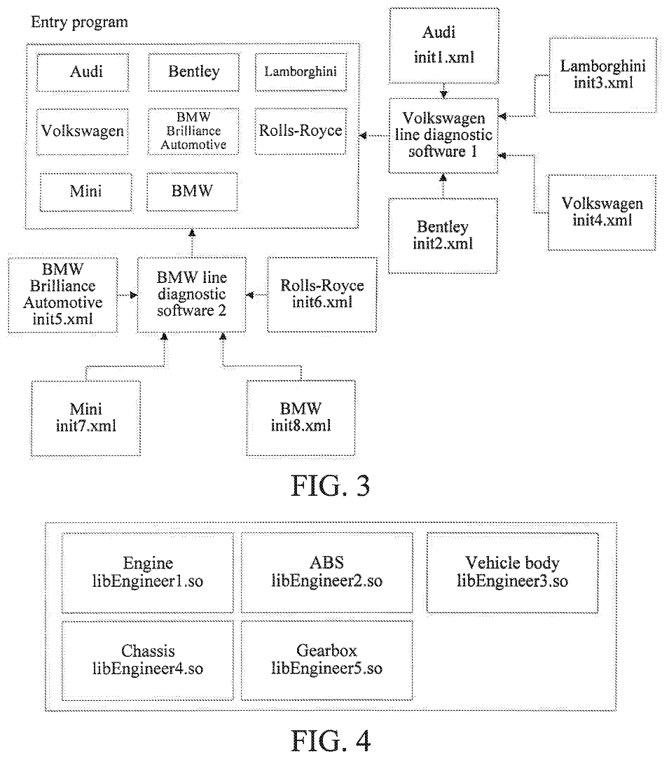

As shown in FIG. 3, each vehicle model has an independent configuration file. A configuration file of Audi is init1.xml; a configuration file of Bentley is init2.xml; a configuration file of Lamborghini is init3.xml; a configuration file of Volkswagen is init4.xml; a configuration file of BMW Brilliance Automotive is init5.xml; a configuration file of Rolls-Royce is init6.xml; a configuration file of Mini is init7.xml; and a configuration file of BMW is init8.xml. A vehicle line to which Audi, Bentley, Lamborghini and Volkswagen belong is a Volkswagen line. A vehicle line to which BMW Brilliance Automotive, Rolls-Royce, Mini and BMW belong is a BMW line. In addition, it is preset that a diagnostic module diagnosing the Volkswagen vehicle line is a “diagnostic module 1”, and a diagnostic module diagnosing the BMW vehicle line is a “diagnostic module 2”. If it is determined that the selected vehicle model is Audi, the obtained configuration file is init1.xml. Configuration information of Audi may be obtained from the configuration file init1.xml. Storage location information of a diagnostic module (the “diagnostic module 1”) of the Volkswagen line to which Audi belongs may be found according to the configuration information. Because the storage location information is used for indicating the storage location of the diagnostic module of the vehicle line, a storage location of the “diagnostic module 1” may be obtained. Further, the diagnostic module is invoked according to the storage location information, that is, the invoked diagnostic module is the “diagnostic module 1”. Similarly, Bentley, Lamborghini and Volkswagen also belong to the Volkswagen line. When the selected vehicle model is Bentley, Lamborghini or Volkswagen, the invoked diagnostic module is also the “diagnostic module 1”. The vehicle line to which BMW Brilliance Automotive, Rolls-Royce, Mini and BMW belong is the BMW line. When the selected vehicle model is BMW Brilliance Automotive, Rolls-Royce, Mini or BMW, the invoked diagnostic module is the “diagnostic module 2”. By invoking the diagnostic module of the vehicle line corresponding to the selected vehicle model, vehicle models of a same vehicle line may share a same diagnostic module to diagnose the selected vehicle model, thereby achieving an objective of sharing the diagnostic module, that is, an objective of data sharing.

It needs to be noted that, the plurality of vehicle lines is not limited to the Volkswagen line and the BMW line. In some embodiments, the plurality of vehicle lines may also be other vehicle lines such as a Mercedes-Benz line, a General Motors line, a Ford line, a Toyota line, and a Peugeot line. In some embodiments, the configuration file may be implemented by a file in another form, for example, a database or a runnable program.

In this embodiment of the present invention, the invoking a diagnostic module of a vehicle line corresponding to the selected vehicle model may include; obtaining a global configuration file of the diagnostic module; and invoking a sub-module of the diagnostic module according to the global configuration file. The global configuration file may be used for maintaining and managing the diagnostic module. Specifically, the invoking a sub-module of the diagnostic module may include: determining, according to the selected vehicle model, a sub-module to be invoked, where at least one sub-module is invoked. In addition, the sub-module includes at least one program library file obtained through division according to a diagnostic function.

FIG. 4 shows a plurality of program library files obtained through division according to diagnostic functions. Specifically, the following program files are generated: a program library file diagnosing an engine of the vehicle model is libEngineer1.so; a program library file diagnosing an ABS of the vehicle model is libEngineer2.so; a program library file diagnosing a vehicle body of the vehicle model is libEngineer3.so; a program library file diagnosing a chassis of the vehicle model is libEngineer4.so; and a program library file diagnosing a gearbox of the vehicle model is libEngineer5.so. If the selected vehicle model is Audi and functions to be diagnosed are the engine and the ABS, corresponding program library files that may be invoked according to the global configuration file are libEngineer1.so and libEngineer2.so, to diagnose the selected vehicle model. Similarly, if the selected vehicle model is BMW and functions to be diagnosed are also the engine and the ABS, program library files of corresponding sub-modules that may be invoked according to the global configuration file are libEngineer1.so and libEngineer2.so, to diagnose the selected vehicle model. Through the program library file of the invoked sub-module, data sharing is implemented for vehicle models in which a same function needs to be diagnosed, so that the storage space occupied by the diagnostic module, and costs for maintaining the diagnostic module are reduced.

In this embodiment of the present invention, a specific procedure of the invoking a diagnostic module of a vehicle line corresponding to the selected vehicle model may include: loading a dynamic library of the diagnostic module of the vehicle line, and obtaining a handle of the dynamic library, where the handle may be interpreted as an identifier that may be used for identifying an object or an item, for example, identifying a dynamic library, and therefore, each dynamic library has a handle used for identifying the dynamic library; and positioning an address of an entry-point function of the diagnostic module according to the handle, and obtaining a function pointer of the entry-point function. Because the function pointer may be used for invoking a function, a sub-module in the diagnostic module may be invoked according to the function pointer. Specifically, the dynamic library may be loaded through a dlopen function, and the address of the entry-point function may be positioned through a dlsym function. In some embodiments, after the diagnosis is completed, the diagnostic function is exited, and the loaded dynamic library is released, so that the diagnostic module works normally when another vehicle model needs to be diagnosed. Specifically, the loaded dynamic library may be released through a dlclose function.

It needs to be noted that, the diagnostic module may be divided according to functions. In some embodiments, the diagnostic module may be divided in another manner. For example, the diagnostic module is divided according to sub-functions, universal modules, or the like.

It needs to be further noted that, in some embodiments, the dynamic library may be loaded through a LoadLibrary function; the address of the entry-point function may be positioned through a GetProcAddress function; and the loaded dynamic library may be released through a FreeLibrary function.

In this embodiment of the present invention, the method further includes:

204: Perform classification processing according to at least one of a code reading manner, fault code translation, a maintenance guidance method and a vehicle model attribute, to set a correspondence between vehicle models and vehicle lines.

Code reading manners, fault code translation, and maintenance guidance methods in a diagnosis procedure for a plurality of different vehicle models may be similar, or even the same. For example, the code reading manners are the same. Alternatively, if a plurality of different vehicle models belongs to one conglomerate, similar features may exist in some component modules (for example, an engine or an ABS) of the vehicle models. For example, Audi and Volkswagen are both vehicle models belonging to Volkswagen, and share basic platforms such as a chassis and an engine. Therefore, Audi and Volkswagen can be classified into a Volkswagen line. If each diagnostic module merely diagnoses one vehicle model, the diagnostic module occupies relatively much storage space. As a result, storage space of a diagnostic tool is in shortage, and maintenance costs of the diagnostic module are also increased. Therefore, classification processing may be performed according to at least one of the reading mariner, the fault code translation, the maintenance guidance method and the vehicle model attribute, to set the correspondence between vehicle models and vehicle lines. For example, normalization processing is performed. The correspondence may be “one-to-one”, or may be “many-to-one”. For example, a plurality of vehicle models belongs to a same vehicle line. For example, a “vehicle line 1” and a “vehicle line 2” are formed according to one or more types of the following information: the code reading manner, the fault code translation, the maintenance guidance method or the vehicle model attribute. A “vehicle model 1”, a “vehicle model 2” and a “vehicle model 3” belong to the “vehicle line 1”. A “vehicle model 4” and a “vehicle model 5” belong to the “vehicle line 2”. The information such as the code reading manner, the fault code translation, the maintenance guidance method or the vehicle model attribute may be bound to the vehicle model and recorded in the mobile terminal, that is, once a vehicle model is determined, information such the code reading manner of the vehicle model may be determined. Alternatively, the mobile terminal obtains, from an external device, the foregoing information according to the vehicle model.

It can be understood that, in some embodiments, step 204 may not be a mandatory step in different embodiments. In addition, in this embodiment of the present invention, steps 201 to 203 and step 204 are not necessarily performed in a particular order. A person of ordinary skill in the art may understand according to descriptions of this embodiment of the present invention that, in different embodiments, steps 201 to 204 may be performed in different orders. For example, step S204 may be performed before step S201, or performed after step S202. When step S204 is performed before step S201, the mobile terminal may determine the correspondence between vehicle models and vehicle lines, and store the correspondence. After the vehicle model of the to-be-diagnosed vehicle is determined, the vehicle line corresponding to the vehicle model of the to-be-diagnosed vehicle may be determined according to the correspondence. Alternatively, step S204 is performed after step S202, that is, after obtaining the vehicle model, the mobile terminal determines the vehicle line corresponding to the vehicle model according to the vehicle model and related information of the vehicle model. Alternatively, as shown in FIG. 2, step S204 is performed after step S203, that is, after diagnosing the to-be-diagnosed vehicle according to the diagnostic module, the mobile terminal may determine, according to a diagnosis result or an operating status of the diagnostic module, whether the vehicle line corresponding to the vehicle model needs to be determined again. If the vehicle line corresponding to the vehicle model needs to be determined again, the mobile terminal performs step S204.

It needs to be further noted that, for technical details that are not described in detail in steps 201 to 204 in this embodiment of the present invention, reference is made to specific descriptions of the foregoing embodiment.

In this embodiment of the present invention, classification processing is performed according to at least one of the code reading manner, the fault code translation, the maintenance guidance method and the vehicle model attribute, to form the vehicle line. In addition, vehicle models adopting a same vehicle line share a same diagnostic module, thereby implementing data sharing, that is, implementing sharing of the diagnostic module. As a result, storage space occupied by the diagnostic module in a diagnostic tool and maintenance costs are reduced.

### Embodiment 3

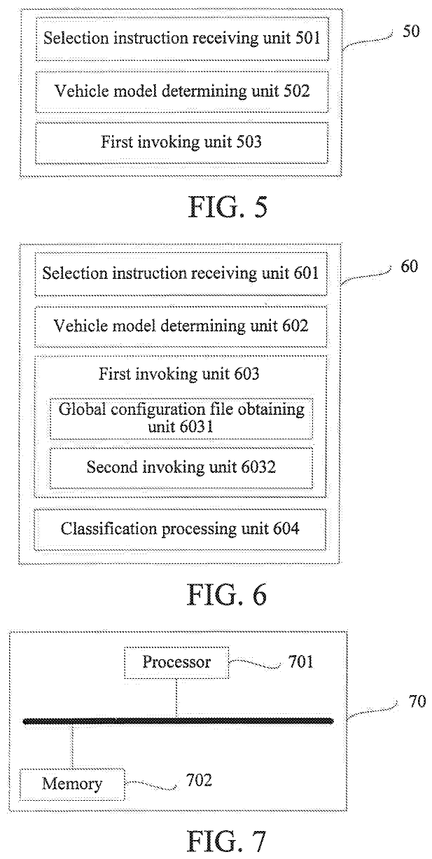

This embodiment of the present invention is an embodiment of a data sharing apparatus provided by the present invention. FIG. 5 is a schematic diagram of a data sharing apparatus according to an embodiment of the present invention. The apparatus is applied to a mobile terminal. The mobile terminal may be a vehicle diagnostic instrument, an embedded computer, or the like.

Referring to FIG. 5, the apparatus 50 includes:

a selection instruction receiving unit 501, configured to receive a vehicle model selection instruction.

In this embodiment of the present invention, a mobile terminal provides an interaction interface. An entry menu for a user to select a vehicle model is displayed in the interaction interface, so that the user performs an operation of vehicle model selection through the entry menu, and a vehicle model selection instruction is generated. The selection instruction receiving unit 501 receives the vehicle model selection instruction. The vehicle model may be formed based on a brand, a manufacturer, a production date, a VIN, or the like of the vehicle, For example, the vehicle model is a vehicle model formed based on the brand of the vehicle, for example, Audi, Bentley or Lamborghini.

A vehicle model determining unit 502, configured to determine a selected vehicle model according to the vehicle model selection instruction.

In this embodiment of the present invention, the vehicle model determining unit 502 may determine, according to the vehicle model selection instruction, a vehicle model selected by the user. For example, the selected vehicle model is Audi.

A first invoking unit 503, configured to invoke a diagnostic module of a vehicle line corresponding to the selected vehicle model according to the selected vehicle model, to diagnose the selected vehicle model.

In this embodiment of the present invention, the first invoking unit 503 invokes a diagnostic module of a vehicle line corresponding to the selected vehicle model according to the selected vehicle model, to diagnose the selected vehicle model. The vehicle line includes a plurality of different vehicle models, and the plurality of different vehicle models shares a diagnostic module of the vehicle line. For example, it is preset that a diagnostic module diagnosing a Volkswagen vehicle line is a “diagnostic module 1”, and a diagnostic module diagnosing a BMW vehicle line is a “diagnostic module 2”. It is determined by the vehicle model determining unit 502 that the selected vehicle model is Audi. According to that the selected vehicle model is Audi, and that a preset vehicle line to which Audi belongs is the Volkswagen line, a diagnostic module invoked by the first invoking unit 503 to diagnose Audi is the “diagnostic module 1”. If Bentley, Lamborghini, or the like also belongs to the Volkswagen line, when the selected vehicle model is Bentley or Lamborghini, the diagnostic module invoked by the first invoking unit 503 is also the “diagnostic module 1”. By invoking the diagnostic module of the vehicle line corresponding to the selected vehicle model, vehicle models of a same vehicle line may share a same diagnostic module, thereby achieving an objective of sharing the diagnostic module, that is, achieving an objective of data sharing.

It needs to be noted that, in this embodiment of the present invention, the data sharing apparatus 50 may perform the data sharing method provided by Embodiment 1 of the present invention, and include corresponding functional modules for performing the method and achieve corresponding beneficial effects. For technical details that are not described in detail in this embodiment of the data sharing apparatus 50, reference is made to the data sharing method provided by Embodiment 1 of the present invention.

### Embodiment 4

This embodiment of the present invention is an embodiment of a data sharing apparatus provided by the present invention. FIG. 6 is a schematic diagram of a data sharing apparatus according to an embodiment of the present invention. The apparatus is applied to a mobile terminal. The mobile terminal may be a vehicle diagnostic instrument, an embedded computer, or the like.

Referring to FIG. 6, the apparatus 60 includes:

a selection instruction receiving unit 601, configured to receive a vehicle model selection instruction.

In this embodiment of the present invention, the selection instruction receiving unit 601 is specifically configured to receive a vehicle model selection instruction entered by a user; or receive a vehicle model selection instruction sent by an external device, for example, receive a vehicle model selection instruction sent by another mobile terminal.

A vehicle model determining unit 602, configured to determine a selected vehicle model according to the vehicle model selection instruction.

A first invoking unit 603, configured to invoke a diagnostic module of a vehicle line corresponding to the selected vehicle model according to the selected vehicle model, to diagnose the selected vehicle model.

In this embodiment of the present invention, the vehicle line includes a plurality of different vehicle models, and the plurality of different vehicle models shares a diagnostic module of the vehicle line. The diagnostic module may include at least one of the following: a function library, a database and an interface. The first invoking unit 603 is specifically configured to: obtain a configuration file of the selected vehicle model; obtain, from the configuration file, configuration information of the selected vehicle model; obtain storage location information of the diagnostic module of the vehicle line corresponding to the selected vehicle model according to the configuration information; and invoke the diagnostic module of the vehicle line according to the storage location information, where the storage location information is used for indicating a storage location of the diagnostic module of the vehicle line. The configuration information includes the storage location information of the diagnostic module of the vehicle line, version information of the diagnostic module of the vehicle line, attribute information of the selected vehicle model, and the like. The version information of the diagnostic module may include a version number of the diagnostic module. A type of the diagnostic module may be determined through the version information of the diagnostic module. For example, it is determined that the diagnostic module is of a standard version, a professional version or an enterprise version. The attribute information of the vehicle model may include a name, a model, and the like of the vehicle model. Quick matching may be performed through the attribute information of the vehicle model included in the configuration file, to obtain the configuration file of the selected vehicle model.

Each vehicle model has an independent configuration file. For example, a configuration file of Audi is init1.xml; a configuration file of Bentley is init2.xml; a configuration file of Lamborghini is init3.xml; a configuration file of Volkswagen is init4.xml; a configuration file of BMW Brilliance Automotive is init5.xml; a configuration file of Rolls-Royce is init6.xml; a configuration file of Mini is init7.xml; and a configuration file of BMW is init8.xml. A vehicle line to which Audi, Bentley, Lamborghini and Volkswagen belong is a Volkswagen line. A vehicle line to which BMW Brilliance Automotive, Rolls-Royce, Mini and BMW belong is a BMW line. In addition, it is preset that a diagnostic module diagnosing the Volkswagen vehicle line is a “diagnostic module 1”, and a diagnostic module diagnosing the BMW vehicle line is a “diagnostic module 2”. If the vehicle model determining unit 602 determines that the selected vehicle model is Audi, the first invoking unit 603 may obtain a configuration file. The obtained configuration file is init1.xml. Configuration information of Audi may be obtained from the configuration file init1.xml. Storage location information of a diagnostic module (the “diagnostic module 1”) of the Volkswagen line to which Audi belongs may be found according to the configuration information. Because the storage location information is used for indicating the storage location of the diagnostic module of the vehicle line, a storage location of the “diagnostic module 1” may be obtained. Further, the diagnostic module is invoked according to the storage location information, that is, the invoked diagnostic module is the “diagnostic module 1”. Similarly, Bentley, Lamborghini and Volkswagen also belong to the Volkswagen line. When the selected vehicle model is Bentley, Lamborghini or Volkswagen, the invoked diagnostic module is also the “diagnostic module 1”. The vehicle line to which BMW Brilliance Automotive, Rolls-Royce, Mini and BMW belong is the BMW line. When the selected vehicle model is BMW Brilliance Automotive, Rolls-Royce, Mini or BMW, the invoked diagnostic module is the “diagnostic module 2”. The first invoking unit 603 invokes the diagnostic module of the vehicle line corresponding to the selected vehicle model, so that vehicle models of a same vehicle line may share a same diagnostic module to diagnose the selected vehicle model, thereby achieving an objective of sharing the diagnostic module, that is, an objective of data sharing.

It needs to be noted that, the plurality of vehicle lines is not limited to the Volkswagen line and the BMW line. In some embodiments, the plurality of vehicle lines may further be other vehicle lines such as a Mercedes-Benz line, a General Motors line, a Ford line, a Toyota line, and a Peugeot line. In some embodiments, the configuration file may be implemented by a file in another form, for example, a database or a runnable program.

In this embodiment of the present invention, the first invoking unit 603 may include: a global configuration file obtaining unit 6031, configured to obtain a global configuration file of the diagnostic module; and a second invoking unit 6032, configured to invoke a sub-module of the diagnostic module according to the global configuration file. The global configuration file may be used for maintaining and managing the diagnostic module. Specifically, the invoking, by the second invoking unit 6032, a sub-module of the diagnostic module may include: determining, according to the selected vehicle model, a sub-module to be invoked, where at least one sub-module is invoked. In addition, the sub-module includes at least one program library file obtained through division according to a diagnostic function.

A plurality of program library files is obtained through division according to diagnostic functions. Specifically, the following program library files are generated: a program library file diagnosing an engine of the vehicle model is libEngineer1.so; a program library file diagnosing an ABS of the vehicle model is libEngineer2.so; a program library file diagnosing a vehicle body of the vehicle model is libEngineer3.so; a program library file diagnosing a chassis of the vehicle model is libEngineer4.so; a program library file diagnosing a gearbox of the vehicle model is libEngineer5.so, and the like. If the selected vehicle model is Audi and functions to be diagnosed are the engine and the ABS, program library files of corresponding sub-modules that may be invoked by the second invoking unit 6032 according to the global configuration file are libEngineer1.so and libEngineer2.so, to diagnose the selected vehicle model. Similarly, if the selected vehicle model is BMW and functions to be diagnosed are also the engine and the ABS, program library files of corresponding sub-modules that may be invoked by the second invoking unit 6032 according to the global configuration file are libEngineer1.so and libEngineer2.so, to diagnose the selected vehicle model. Through the program library file of the invoked sub-module, data sharing is implemented for vehicle models in which a same function needs to be diagnosed, so that the storage space occupied by the diagnostic module, and costs for maintaining the diagnostic module are reduced.

In this embodiment of the present invention, the invoking, by the first invoking unit 603, a diagnostic module of a vehicle line corresponding to the selected vehicle model may include: loading a dynamic library of the diagnostic module of the vehicle line, and obtaining a handle of the dynamic library, where the handle may be interpreted as an identifier that may be used for identifying an object or an item, for example, identifying a dynamic library, and therefore, each dynamic library has a handle used for identifying the dynamic library; and positioning an address of an entry-point function of the diagnostic module according to the handle, and obtaining a function pointer of the entry-point function. Because the function pointer may be used for invoking a function, a sub-module in the diagnostic module may be invoked according to the function pointer. Specifically, the dynamic library may be loaded through a dlopen function, and the address of the entry-point function may be positioned through a dlsym function. In some embodiments, after the diagnosis is completed, a diagnostic function is exited, and the first invoking unit 603 may further release the loaded dynamic library, so that the diagnostic module works normally when another vehicle model needs to be diagnosed. Specifically, the loaded dynamic library may be released through a enclose function.

It needs to be noted that, the diagnostic module may be divided according to functions. In some embodiments, the diagnostic module may be divided in another manner. For example, the diagnostic module is divided according to sub-functions, universal modules, or the like.

It needs to be further noted that, in some embodiments, the first invoking unit 603 may load the dynamic library through a LoadLibrary function; position the address of the entry-point function through a GetProcAddress function; and release the loaded dynamic library through a FreeLibrary function.

In this embodiment of the present invention, the apparatus 60 further includes:

a classification processing unit 604, configured to perform classification processing according to at least one of a code reading manner, fault code translation, a maintenance guidance method and a vehicle model attribute, to set a correspondence between vehicle models and vehicle lines.

Code reading manners, fault code translation, and maintenance guidance methods in a diagnosis procedure for a plurality of different vehicle models may be similar, or even the same. For example, the code reading manners are the same. Alternatively, if a plurality of different vehicle models belongs to one conglomerate, similar features may exist in some component modules (for example, an engine or an ABS) of the vehicle models. For example, Audi and Volkswagen are both vehicle models belonging to Volkswagen, and share basic platforms such as a chassis and an engine. Therefore, Audi and Volkswagen can be classified into a Volkswagen line. If each diagnostic module merely diagnoses one vehicle model, the diagnostic module occupies relatively much storage space. As a result, storage space of a diagnostic tool is in shortage, and maintenance costs of the diagnostic module are also increased. Therefore, the classification processing unit 604 may perform classification processing according to at least one of the code reading manner, the fault code translation, the maintenance guidance method and the vehicle model attribute, to set the correspondence between vehicle models and vehicle lines. For example, normalization processing is performed. The correspondence may be “one-to-one”, or may be “many-to-one”. For example, a plurality of vehicle models belongs to a same vehicle line. For example, a “vehicle line 1” and a “vehicle line 2” are formed according to the code reading manner, the fault code translation, the maintenance guidance method and the vehicle model attribute. A “vehicle model 1”, a “vehicle model 2” and a “vehicle model 3” belong to the “vehicle line 1”. A “vehicle model 4” and a “vehicle model 5” belong to the “vehicle line 2”.

It needs to be noted that, in this embodiment of the present invention, the data sharing apparatus 60 may perform the data sharing method provided by Embodiment 2 of the present invention, and include corresponding functional modules for performing the method and achieve corresponding beneficial effects. For technical details that are not described in detail in this embodiment of the data sharing apparatus 60, reference is made to the data sharing method provided by Embodiment 2 of the present invention.

### Embodiment 5

FIG. 7 is a schematic structural diagram of hardware of a mobile terminal according to an embodiment of the present invention. As shown in FIG. 7, the mobile terminal 70 includes:

one or more processors 701 and a memory 702. One processor 701 is used as an example in FIG. 7.

The processor 701 and the memory 702 may be connected by using a bus or in other manners. In FIG. 7, as an example, connection is performed by using a bus.

As a non-volatile computer-readable storage medium, the memory 702 may be configured to store a non-volatile software program, a non-volatile computer executable program and a module, for example, a program instruction/unit corresponding to the data sharing method in the embodiments of the present invention (for example, the selection instruction receiving unit 601, the vehicle model determining unit 602, the first invoking unit 603 and the classification processing unit 604 that are shown in FIG. 6). The processor 701 runs the non-volatile software program, an instruction and a unit that are stored in the memory 702, to implement various functional applications and data processing of the mobile terminal, that is, to implement the data sharing method in the method embodiment.

The memory 702 may include a program storage area and a data storage area. The program storage area may store an operating system, and an application program required by at least one function. The data storage area may store data created according to use of the mobile terminal, and the like. In addition, the memory 702 may include a high speed random access memory, and may also include a non-volatile memory such as at least one magnetic disk storage device, a flash memory, or another non-volatile solid-state storage device. In some embodiments, the memory 702 may optionally include memories remotely disposed relative to the processor 701, and these remote memories may be connected to the mobile terminal through a network. Embodiments of the network include, but are not limited to, the Internet, an intranet, a local area network, a mobile communications network, and a combination thereof.

The one or more units are stored in the memory 702. The one or more units, when being executed by the one or more processors 701, perform the data sharing method in either of the method embodiment 1 and/or the embodiment 2, for example, perform steps 201 to 204 of the method in FIG. 2 and implement functions of the units 601 to 604 in FIG. 6.

The mobile terminal may perform the data sharing method provided by Embodiment 1 and/or Embodiment 2 of the present invention, and include corresponding functional modules for performing the method and achieve beneficial effects. For technical details that are not described in detail in this embodiment of the mobile terminal, reference is made to the data sharing method provided by the embodiment 1 and/or the embodiment 2 of the present invention.

An embodiment of the present invention provides a computer program product, including a computer program stored in a non-volatile computer-readable storage medium. The computer program includes a program instruction, the program instruction, when being executed by a mobile terminal, causing the mobile terminal to perform the foregoing data sharing method. For example, the mobile terminal performs steps 201 to 204 of the method in FIG. 2 and implements functions of the units 601 to 604 in FIG. 6.

An embodiment of the present invention provides a non-volatile computer-readable storage medium storing a computer executable instruction, the computer executable instruction being executed by one or more processors, to perform the foregoing data sharing method. For example, the computer executable instruction performs steps 201 to 204 of the method in FIG. 2 and implements functions of the units 601 to 604 in FIG. 6.

The mobile terminal in this embodiment of the present invention may exist in a plurality of forms, including, but not limited to:

(1) A vehicle diagnostic instrument: This type of mobile terminal is a professional instrument specifically for vehicle detection, which can detect performance of a vehicle in real time and detect a vehicle fault, and is a tool necessary for vehicle detection. The vehicle diagnostic instrument may include: a handheld vehicle diagnostic instrument, a mobile vehicle diagnostic instrument, or the like.

(2) An embedded computer: This type of mobile terminal is generally a “special-purpose” computer, which is a computer for a specific application, for example, a computer for a vehicle diagnosis. The mobile terminal is an application-centered special-purpose computer applied to an application system, where the special-purpose computer has strict requirements for functions, reliability, costs, a volume, and power consumption.

(3) Other mobile terminals with a data sharing function.

It needs to be noted that, the described apparatus embodiment is merely exemplary. The units described as separate parts may or may not be physically separated, and parts displayed as units may or may not be physical units, may be located in one position, or may be distributed on a plurality of network units. Some or all modules thereof may be selected based on an actual requirement, to implement an objective of the solution in this embodiment.

Through the description of the foregoing embodiments, a person of ordinary skill in the art may clearly understand that the embodiments may be implemented by software in combination with a universal hardware platform, and may certainly be implemented by hardware. A person of ordinary skill in the art may understand that all or some of the processes of the methods in the embodiments may be implemented by a computer program instructing relevant hardware. The program may be stored in a computer readable storage medium. When the program runs, the processes of the methods in the embodiments are performed. The foregoing storage medium may include: a magnetic disk, an optical disc, a read-only memory (ROM), a random access memory (RAM), or the like.

Finally, it should be noted that the foregoing embodiments are merely intended for describing the technical solutions of the present invention, but not for limiting the present invention. In the idea of the present invention, technical features in the foregoing embodiments or in different embodiments may also be combined. Steps may be performed in any order, and many other modifications may exist in different aspects of the present invention. For simplicity, they are not provided in the details. Although the present invention is described in detail with reference to the foregoing embodiments, a person of ordinary skill in the art should understand that they may still make modifications to the technical solutions described in the foregoing embodiments or make equivalent replacements to some technical features thereof, without departing from the scope of the technical solutions of the embodiments of the present invention.

What is claimed is;:

1. A data sharing method, applied to a mobile terminal, the method comprising:
receiving a vehicle model selection instruction;
determining a selected vehicle model according to the vehicle model selection instruction; and
invoking a diagnostic module of a vehicle line corresponding to the selected vehicle model according to the selected vehicle model, to diagnose the selected vehicle model, wherein the vehicle line comprises a plurality of different vehicle models, and the plurality of different vehicle models shares the diagnostic module of the vehicle line.

2. The method according to claim 1, wherein the invoking a diagnostic module of a vehicle line corresponding to the selected vehicle model according to the selected vehicle model comprises;
obtaining a configuration file of the selected vehicle model;
obtaining, from the configuration file, configuration information of the selected vehicle model;
obtaining storage location information of the diagnostic module of the vehicle line corresponding to the selected vehicle model according to the configuration information, wherein the storage location information is used for indicating a storage location of the diagnostic module of the vehicle line; and
invoking the diagnostic module of the vehicle line according to the storage location information.

3. The method according to claim 2, wherein the configuration information comprises the storage location information of the diagnostic module of the vehicle line and version information of the diagnostic module of the vehicle line.

4. The method according to claim 3, wherein the configuration information further comprises attribute information of the selected vehicle model.

5. The method according to claim 1, wherein the invoking a diagnostic module of a vehicle line corresponding to the selected vehicle model comprises:
obtaining a global configuration file of the diagnostic module; and
invoking a sub-module of the diagnostic module according to the global configuration file.

6. The method according to claim 5, wherein the sub-module comprises at least one program library file obtained through division according to a diagnostic function.

7. The method according to claim 1, wherein the invoking a diagnostic module of a vehicle line corresponding to the selected vehicle model comprises:
loading a dynamic library of the diagnostic module of the vehicle line, and obtaining a handle of the dynamic library;
positioning an address of an entry-point function of the diagnostic module according to the handle, and obtaining a function pointer of the entry-point function; and
invoking the diagnostic module according to the function pointer.

8. The method according to claim 1, further comprising:
performing classification processing according to at least one of a code reading manner, fault code translation, a maintenance guidance method and a vehicle model attribute, to set a correspondence between vehicle models and vehicle lines.

9. The method according to claim 1, wherein the receiving a vehicle model selection instruction comprises:
receiving a vehicle model selection instruction entered by a user; or
receiving a vehicle model selection instruction sent by an external device.

10. A data sharing apparatus, applied to a mobile terminal, the apparatus comprising:
a selection instruction receiving unit, configured to receive a vehicle model selection instruction;
a vehicle model determining unit, configured to determine a selected vehicle model according to the vehicle model selection instruction; and
a first invoking unit, configured to invoke a diagnostic module of a vehicle line corresponding to the selected vehicle model according to the selected vehicle model, to diagnose the selected vehicle model, wherein the vehicle line comprises a plurality of different vehicle models, and the plurality of different vehicle models shares the diagnostic module of the vehicle line.

11. The apparatus according to claim 10, wherein the first invoking unit is specifically configured to:
obtain a configuration file of the selected vehicle model;
obtain, from the configuration file, configuration information of the selected vehicle model;
obtain storage location information of the diagnostic module of the vehicle line corresponding to the selected vehicle model according to the configuration information, wherein the storage location information is used for indicating a storage location of the diagnostic module of the vehicle line; and
invoke the diagnostic module of the vehicle line according to the storage location information.

12. The apparatus according to claim 11, wherein the configuration information comprises the storage location information of the diagnostic module of the vehicle line and version information of the diagnostic module of the vehicle line.

13. The apparatus according to claim 12, wherein the configuration information further comprises attribute information of the selected vehicle model.

14. The apparatus according to claim 11, wherein the first invoking unit comprises:
a global configuration file obtaining unit, configured to obtain a global configuration file of the diagnostic module; and
a second invoking unit, configured to invoke a sub-module of the diagnostic module according to the global configuration file.

15. The apparatus according to claim 14, wherein the sub-module comprises at least one program library file obtained through division according to a diagnostic function.

16. The apparatus according to claim 10, wherein the invoking, by the first invoking unit, a diagnostic module of a vehicle line corresponding to the selected vehicle model comprises:
loading a dynamic library of the diagnostic module of the vehicle line, and obtaining a handle of the dynamic library;
positioning an address of an entry-point function of the diagnostic module according to the handle, and obtaining a function pointer of the entry-point function; and
invoking the diagnostic module according to the function pointer.

17. The apparatus according to claim 10, further comprising:
a classification processing unit, configured to perform classification processing according to at least one of a code reading manner, fault code translation, a maintenance guidance method and a vehicle model attribute, to set a correspondence between vehicle models and vehicle lines.

18. The apparatus according to claim 10, wherein the selection instruction receiving unit is specifically configured to:
receive a vehicle model selection instruction entered by a user; or
receive a vehicle model selection instruction sent by an external device.

19. A mobile terminal, comprising:
at least one processor; and
a memory communicatively connected to the at least one processor, wherein
the memory stores instructions executable by the at least one processor, the instructions being executed by the at least one processor to cause the at least one processor to receive a vehicle model selection instruction; determine a selected vehicle model according to the vehicle model selection instruction; and invoke a diagnostic module of a vehicle line corresponding to the selected vehicle model according to the selected vehicle model, to diagnose the selected vehicle model, wherein the vehicle line comprises a plurality of different vehicle models, and the plurality of different vehicle models shares the diagnostic module of the vehicle line.
